(19) United States
(12) Patent Application Publication
(10) Pub. No.: US 2009/0235213 A1
(43) Pub. Date: Sep. 17, 2009

(54) Layout-Versus-Schematic Analysis For Symmetric Circuits

(76) Inventors: Xin Hao, Wilsonvile, OR (US); Fedor G. Pikus, Beaverton, OR (US); Thomas L. Quarles, Beaverton, OR (US)

Correspondence Address: MENTOR GRAPHICS CORP.;PATENT GROUP, 8005 SW BOECKMAN ROAD, WILSONVILLE, OR, 97070-7777, US

(21) Appl. No.: 12/248,032

(22) Filed: Oct. 8, 2008

Related U.S. Application Data
(60) Provisional application No. 60/978,390, filed on Oct. 8, 2007.

(51) Int. Cl. G06F 17/50

(52) U.S. Cl. 716/4

(57) ABSTRACT

Techniques for reducing the complexity of Electronic Design Automation Layout-Versus-Schematic algorithms to approximately O(n) for graphs without type-3 symmetries.

### RELATED APPLICATIONS

This application claims priority under 35 U.S.C. §119 to U.S. Provisional Patent Application No. 60/978,390, filed on Oct. 8, 2007, entitled “Layout-Versus-Schematic Analysis For Symmetric Circuits,” and naming Xin Hao et al. as inventors, which application is incorporated entirely herein by reference.

### BACKGROUND OF THE INVENTION

LVS (Layout-Versus-Schematic) is a graph comparison technique widely used to prove that the topological structure of a circuit layout is equivalent to the designed or synthesized transistor-level schematic. It is nearly universally applied in VLSI design to verify the consistency of a circuit extracted from physical layout with that of the circuit specification. The equivalence of layout and schematic implies that the topological structures of the layout and schematic must be isomorphic and that the corresponding instances and nets must have identical types and properties within a tolerance allowed by designers.

Often the topological structures of both schematics and layout are modeled by hyper-graphs where hyper-edges represent nets. By replacing hyper-edges with nodes of a type distinguishable from the original nodes, hyper-graphs can be uniquely mapped onto bipartite graphs in linear time. The LVS problem can then be solved by comparing two bipartite graphs, one based on circuit extraction and one derived from the design specification. FIG. 1 shows the hyper-graph and corresponding bipartite graph representations of a 6-transistor memory cell.

The LVS problem drew a lot of attention in the 1980s, but there have been few new results in recent years on this very important step in EDA design verification. Most early LVS algorithms are based on a partition refinement model in which each node is assigned a label and all nodes with identical labels are placed in a class. The initial values of the labels are generated from the nodes' local properties (names, types, etc.). In each iteration, the labels are propagated to the neighboring nodes and the classes are refined accordingly. When an unbalanced class in which the numbers of nodes from layout and schematics are not equal is detected, the algorithm reports that the two graphs are different. If a class includes only one node from each graph, it is called a singleton class, otherwise it is called an ambiguity class. Two nodes in a singleton class are obviously matched. When the algorithm finishes without any unbalanced classes, the two graphs are reported equivalent. This model works in most practical cases but can run rather slowly. Numerous improvements by were suggested to deal with subgraph or hierarchical graph comparison, but the above partition-refinement model was still used as infrastructure.

The performance of the above partition refinement model is strongly affected by the existence and number of symmetric nodes. Any two nodes of the same graph in an ambiguity class are called symmetric nodes, and the graphs owning symmetric nodes are symmetric graphs. In each example shown in FIG. 2, node A and B (or A′ and B′) are symmetric nodes because they are in same class initially. When the partition refinement reaches a fixed-point, i.e. all classes can no longer be refined, the original symmetric nodes A and B may have one of the following relations:
Type-1: The nodes fall into different classes.
Type-2: The nodes stay in the same class along with A′ and B′. The two graphs can be made equivalent by matching A to A′ and B to B′ and they also can be made equivalent by matching A to B′ and B to A′.
Type-3: The nodes stay in the same class along with A′ and B′. The two graphs can be made equivalent by matching A to A′ and B to B′, but not by matching A to B′ and B to A′.

Type-2 is true symmetry, type-3 is apparent symmetry based on information observed so far. Partition-refinement cannot break type-2 or type-3 symmetries and a guess or probationary assignment is made. Type-2 symmetry costs little because the equivalence of the graphs is not affected by such a guess. When type-3 symmetry exists, all possible matches must be explored before the two graphs are reported to be different and usually an expensive backtracking scheme is required. Note that a similar phenomenon can be seen for type-1 symmetry: a guess might be made before two type-1 symmetric nodes A and B are separated. The two graphs are equivalent if nodes A and B are correctly matched to nodes A′ and B′ respectively, however an incorrect matching (A to B′ and B to A′) will make the graphs falsely appear non-equivalent. Type-1 and type-3 symmetries are totally different. Type-1 symmetry disappears in the succeeding partition refinement while type-3 symmetry does not. Making a guess on a type-1 symmetry is unnecessary and error-prone. Type-1 and Type-2 symmetries will be discussed in detail below. Thankfully, type-3 symmetry is rarely seen in practice, thus it is not discussed in this paper.

Type-1 symmetry can be broken by the differing relations of the symmetric nodes and some reference node. For example, in FIG. 2(a), node A is adjacent to the end node C but node B is not, thus node A and node B are distinguished by node C. Notice that the reference nodes are not necessarily immediate neighbor nodes and can be in singleton classes, or the symmetric nodes such as node C in FIG. 2(a). Traditional LVS algorithms work quite well when reference nodes are not themselves symmetric, however, the performance degrades dramatically when they are symmetric because the local matching step in the traditional algorithm can only use nodes in singleton classes as reference nodes.

Often the reference node is located far away from the symmetric nodes. A typical example is a long symmetric chain. The nodes at both ends are the reference nodes because each of them connects one net while others connect two. All other nodes of the chain are classified by their distance from the ends. If the reference nodes are ambiguous, in the worst case traditional algorithms take O(n2) run-time. (C. Ebeling, for example, observed a practical run-time estimate O(n1.85) on highly symmetric circuits. See, C. Ebling, “Gemini II: A Second Generation Layout Validation Program,” in Proc. IEEE/ACM Int. Computer-Aided Design Conf., 1988, pp. 322-325, which article is incorporated entirely herein by reference.) Unfortunately, symmetric long chains or their variant forms, such as buffer chains, memory, register files, and data-paths appear very frequently in real designs. Note that O(n1.85) may not seem all that bad, but a large LVS problem can have over 109 transistors and a similar numbers of nets.

### SUMMARY OF THE INVENTION

Various implementations of the invention provide techniques that are able to reduce the complexity of the LVS algorithm to approximately O(n) for most graphs without type-3 symmetries. For example, the various implementations of the invention may reduce the run-time of a typical example with hundreds of thousands of symmetric nodes from hours to seconds. These and other features and aspects of the invention will be apparent upon consideration of the following detailed description.

### BRIEF DESCRIPTION OF THE DRAWINGS

FIG. 1 shows the hyper-graph and corresponding bipartite graph representations of a 6-transistor memory cell.

FIG. 2 illustrates examples of graphs with symmetric nodes.

FIG. 3 illustrates the components of a computer network having a host or master computer and one or more remote or servant computers that may be employed with various embodiments of the invention.

FIG. 4 illustrates an example of a multi-core processor unit that may be employed with various embodiments of the invention.

FIG. 5 shows three examples of circuit devices arranged in circuits.

FIG. 6(a) shows an example of a chain graph with 10 nodes.

FIG. 6(b) shows how labels for the node illustrated in FIG. 6(a) change using a traditional graph-comparison algorithm.

FIGS. 7(a)-7(b) illustrate a disambiguation of node classes in a graph according to various embodiments of the invention.

FIG. 8 illustrates how a graph with n nodes can be disambiguated in close to O(n) number of operations according to various embodiments of the invention.

FIGS. 9(a)-9(c) illustrate how a doubly linked list data structure can be used to disambiguate node classes in a graph according to various embodiments of the invention.

FIG. 10 illustrates how all classes of a graph may be sorted by size and stored in an array of groups to find the smallest unvisited class according to various embodiments of the invention.

FIG. 11 show the results obtained from employing an implementation of the invention to circuit arrangements illustrated in FIG. 5.

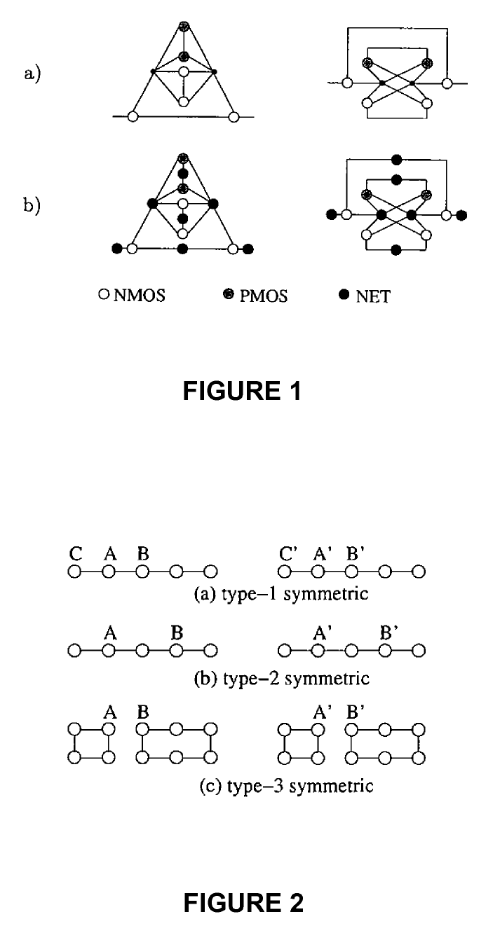

### DETAILED DESCRIPTION OF THE INVENTION

### Exemplary Operating Environment

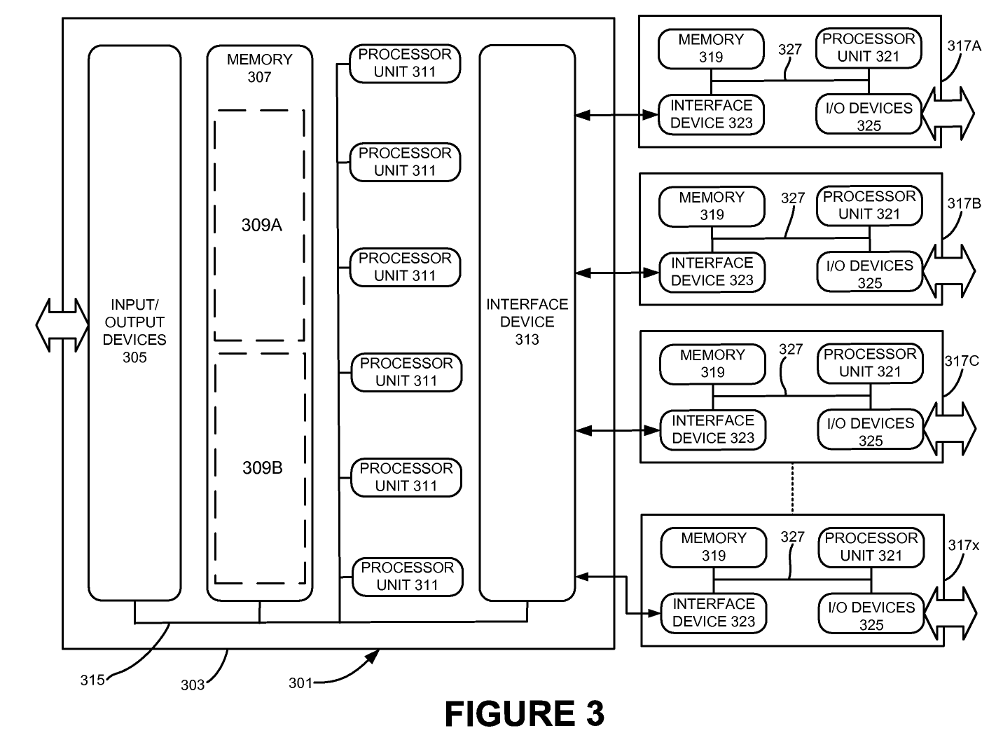

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 3. This operating environment is only one example of a suitable operating environment, however, and is not intended to suggest any limitation as to the scope of use or functionality of the invention.

In FIG. 3, the computer network 301 includes a master computer 303. In the illustrated example, the master computer 303 is a multi-processor computer that includes a plurality of input and output devices 305 and a memory 307. The input and output devices 305 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 307 may similarly be implemented using any combination of computer readable media that can be accessed by the master computer 303. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 303 runs a software application for performing one or more operations according to various examples of the invention. Accordingly, the memory 307 stores software instructions 309A that, when executed, will implement a software application for performing one or more operations. The memory 307 also stores data 309B to be used with the software application. In the illustrated embodiment, the data 309B contains process data that the software application uses to perform the operations, at least some of which may be parallel.

The master computer 303 also includes a plurality of processor units 311 and an interface device 313. The processor units 311 may be any type of processor device that can be programmed to execute the software instructions 309A, but will conventionally be a microprocessor device. For example, one or more of the processor units 311 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 311 may be a custom-manufactured processor, such as a microprocessor designed to optimally perform specific types of mathematical operations. The interface device 313, the processor units 311, the memory 307 and the input/output devices 305 are connected together by a bus 315.

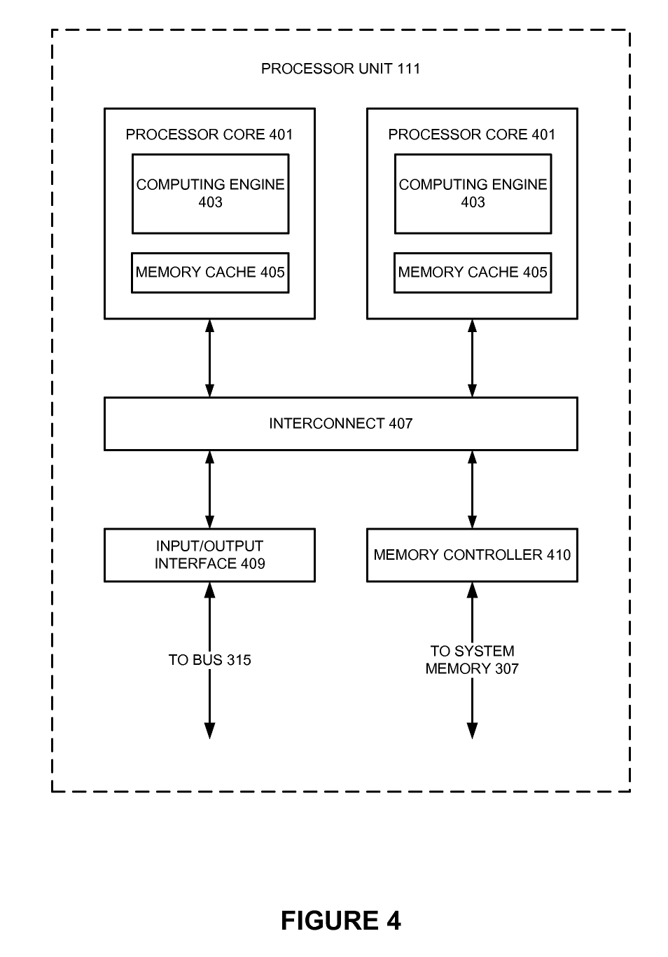

With some implementations of the invention, the master computing device 303 may employ one or more processing units 311 having more than one processor core. Accordingly, FIG. 4 illustrates an example of a multi-core processor unit 311 that may be employed with various embodiments of the invention. As seen in this figure, the processor unit 311 includes a plurality of processor cores 401. Each processor core 401 includes a computing engine 403 and a memory cache 405. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 403 may then use its corresponding memory cache 405 to quickly store and retrieve data and/or instructions for execution.

Each processor core 401 is connected to an interconnect 407. The particular construction of the interconnect 407 may vary depending upon the architecture of the processor unit 401. With some processor cores 401, such as the Cell microprocessor created by Sony Corporation, Toshiba Corporation and IBM Corporation, the interconnect 407 may be implemented as an interconnect bus. With other processor units 401, however, such as the Opteron™ and Athlon™ dual-core processors available from Advanced Micro Devices of Sunnyvale, Calif., the interconnect 407 may be implemented as a system request interface device. In any case, the processor cores 401 communicate through the interconnect 407 with an input/output interface 409 and a memory controller 411. The input/output interface 409 provides a communication interface between the processor unit 401 and the bus 315. Similarly, the memory controller 411 controls the exchange of information between the processor unit 401 and the system memory 307. With some implementations of the invention, the processor units 401 may include additional components, such as a high-level cache memory accessible shared by the processor cores 401.

While FIG. 4 shows one illustration of a processor unit 401 that may be employed by some embodiments of the invention, it should be appreciated that this illustration is representative only, and is not intended to be limiting. For example, some embodiments of the invention may employ a master computer 303 with one or more Cell processors. The Cell processor employs multiple input/output interfaces 409 and multiple memory controllers 411. Also, the Cell processor has nine different processor cores 401 of different types. More particularly, it has six or more synergistic processor elements (SPEs) and a power processor element (PPE). Each synergistic processor element has a vector-type computing engine 403 with 428×428 bit registers, four single-precision floating point computational units, four integer computational units, and a 556 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 311 can be used in lieu of multiple, separate processor units 311. For example, rather than employing six separate processor units 311, an alternate implementation of the invention may employ a single processor unit 311 having six cores, two multi-core processor units each having three cores, a multi-core processor unit 311 with four cores together with two separate single-core processor units 311, etc.

Returning now to FIG. 3, the interface device 313 allows the master computer 303 to communicate with the servant computers 317A, 317B, 317C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 313 translates data and control signals from the master computer 303 and each of the servant computers 317 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 317 may include a memory 319, a processor unit 321, an interface device 323, and, optionally, one more input/output devices 325 connected together by a system bus 327. As with the master computer 303, the optional input/output devices 325 for the servant computers 317 may include any conventional input or output devices, such as keyboards, pointing devices, microphones, display monitors, speakers, and printers. Similarly, the processor units 321 may be any type of conventional or custom-manufactured programmable processor device. For example, one or more of the processor units 321 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 321 may be custom-manufactured processors, such as microprocessors designed to optimally perform specific types of mathematical operations. Still further, one or more of the processor units 321 may have more than one core, as described with reference to FIG. 4 above. For example, with some implementations of the invention, one or more of the processor units 321 may be a Cell processor. The memory 319 then may be implemented using any combination of the computer readable media discussed above. Like the interface device 313, the interface devices 323 allow the servant computers 317 to communicate with the master computer 303 over the communication interface.

In the illustrated example, the master computer 303 is a multi-processor unit computer with multiple processor units 311, while each servant computer 317 has a single processor unit 321. It should be noted, however, that alternate implementations of the invention may employ a master computer having single processor unit 311. Further, one or more of the servant computers 317 may have multiple processor units 321, depending upon their intended use, as previously discussed. Also, while only a single interface device 313 or 323 is illustrated for both the master computer 303 and the servant computers, it should be noted that, with alternate embodiments of the invention, either the computer 303, one or more of the servant computers 317, or some combination of both may use two or more different interface devices 313 or 323 for communicating over multiple communication interfaces.

With various examples of the invention, the master computer 303 may be connected to one or more external data storage devices. These external data storage devices may be implemented using any combination of computer readable media that can be accessed by the master computer 303. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 317 may alternately or additionally be connected to one or more external data storage devices. Typically, these external data storage devices will include data storage devices that also are connected to the master computer 303, but they also may be different from any data storage devices accessible by the master computer 303.

It also should be appreciated that the description of the computer network illustrated in FIG. 3 and FIG. 4 is provided as an example only, and it not intended to suggest any limitation as to the scope of use or functionality of alternate embodiments of the invention.

### Conventional Layout-Versus Schematic Algorithm

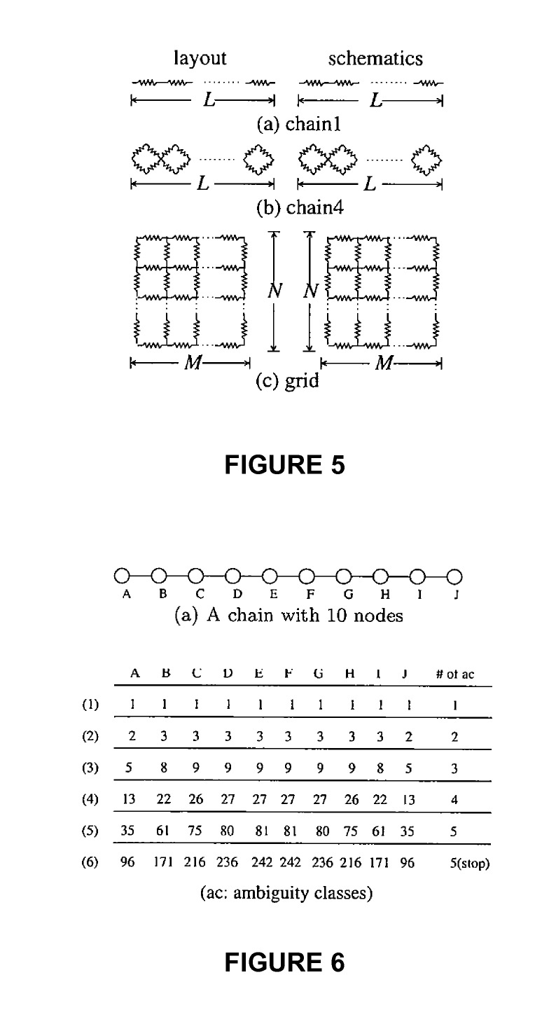

A traditional LVS algorithm is shown in Listing 1 below. This algorithm works very well when singleton classes can be found in very early stages and most ambiguity classes can be resolved through local singleton classes, otherwise a lot of time will be spent on step (5). FIG. 5 shows three examples. The first one is a chain of L instances. The second one is a chain of diamond shaped instances and the third one is a grid of size M×N. All instances are of the same type. For the sake of simplicity, the instances are represented as resistors, but they can be any type of 2-pin devices or sub-circuit. Device reduction has not been applied in these examples in order to illustrate the complexity of topological verification.

Algorithm 1 A traditional LVS Algorithm

| | |
|---|---|
| 1: | convert the original graphs to bipartite graphs |
| 2: | each node is assigned an initial integer label with invariants |
| 3: | do |
| 4: | do |
| 5: | update the labels of all nodes with their neighbors |
| 6: | split or generate classes according to the labels |
| 7: | match the nodes in singleton classes |
| 8: | do |
| 9: | update the neighbors of nodes in singleton classes |
| 10: | until all singleton classes are visited |
| 11: | until no classes can be split |
| 12: | if there is any ambiguity class |
| 13: | make a guess arbitrarily |
| 14: | until all nodes are matched |
| 15: | if there is any unbalanced class |
| 16: | report that the two graphs are different |
| 17: | else |
| 18: | report that the two graphs are equivalent. |

### Listing 1

Note that in all examples, each node (either instance or net) not at the center has at least one symmetric node on the same graph, thus at most one singleton class can be found in step (7) and this singleton class does not help to split other classes. Let n be the number of nodes and d be the largest distance between a symmetric node and a reference node. Step (5) is executed d times until a fixed-point is reached and n nodes will be updated in each iteration. Thus the total amount of calculation is (n·d). Table 1 below illustrates that the complexities are close to O(n²), O(n²), and O(n\sqrt{n}) with the traditional algorithm.

TABLE 1
runtime of a commercial lvs tool

| chain1 | | chain4 | | grid | | |
|---|---|---|---|---|---|---|
| L | runtime | L | runtime | M | N | runtime |
| 1000 | 0 sec | 1000 | 5 sec | 40 | 40 | 0 sec |
| 2000 | 1 sec | 2000 | 38 sec | 80 | 80 | 1 sec |
| 4000 | 6 sec | 4000 | 177 sec | 160 | 160 | 8 sec |
| 8000 | 36 sec | 8000 | 1103 sec | 320 | 320 | 71 sec |
| 16000 | 184 sec | 16000 | 3910 sec | 640 | 640 | 645 sec |

The performance becomes even worse when a graph G has two independent parts G₁ and G₂. Suppose sub-graph G₁ has n₁ type-2 symmetric nodes and runs d₁ iterations to reach a fixed-point. (Local matching is not counted in the number of iterations.) The run-time of G₁ alone is t₁. Sub-graph G₂ runs d₂ (d₂>d₁) iterations to reach a fixed-point. The run-time of G₂ alone is t₂. When two sub-graphs are put together, the run-time of the overall graph G is not t₁+t₂, but t₁+t₂+T·n₁·(d₂−d₁), because all type-2 symmetric nodes have to be updated in each iteration (T is the time spent on updating each node). Thus the traditional algorithm relies on a good preprocessing routine to isolate independent sub-graphs.

In addition to run-time issues, the hash-function based class naming scheme is another source of trouble. Although the effect of hash collisions can be minimized by a careful choice of hash function, it cannot be removed completely as long as the label is generated based on a hash function. Additional steps must be taken to resolve collisions.

The proposed algorithm improves this traditional algorithm in two areas: (1) Removing the redundant calculations; (2) Applying a new data structure. The complexity of the new algorithm is close to O(n). No hash function is involved and the risk of hash collisions is eliminated completely. Sub-graph isolation and local matching are realized implicitly in the new algorithm, thus there is no special partitioning routine required.

### Redundant Calculations

FIG. 6(a) shows an example of a chain with 10 nodes. The layout graph and schematic graph are identical, thus only one is shown here. In order to make the algorithm more general, the graphs discussed herein are not limited to bipartite graphs unless explicitly stated.

FIG. 6(b) shows how the labels change via the traditional algorithm. The initial labels are selected arbitrarily and the hash function is the summation of the labels of a node and its neighbors. Note that in this example all classes are ambiguous, thus local matching is not invoked and the labels of all nodes are updated in each iteration. The number of label calculation steps is 5×10=50. Generally, for a chain length of n, the number of label calculations is n²/2 (n is even) or n(n+1)/2+1 (n is odd) times. Notice that there is a singleton class if n is odd, but this singleton class cannot refine its neighbors. Clearly the complexity is O(n²).

A fact can be seen in FIG. 6(b): although the labels of some nodes in a class are changed, they still stay in the same class because their labels are updated based on neighbors whose labels are identical. Any relabeling function based on neighbors can only assign new labels, but cannot separate them into different classes. For example, in FIG. 6(b):
(1) Nodes A and J are in the same class initially and their neighbors B and I are always in the same class, thus A and J must be in same class no matter how their labels change.
(2) The neighbors of nodes {CDEFGH} are {BCDEFGHI} which are in same class in the second iteration, thus {CDEFGH} must be in same class in the third iteration.
(3) Nodes B and I are in same class with {CDEFGH} in the second iteration, but their neighbors A and J are not in the same class with {CDEFGH}, thus they are split from the original class in the third iteration.

Based on the above observation, the following lemma is found:
LEMMA 1. In each iteration of partition-refinement, if two nodes N₁ and N₂ in a class have a different number of neighbors in some class, then N₁ and N₂ will be separated in the next iteration. Otherwise, if N₁ and N₂ have an identical number of neighbors in every class, then they will stay in the same class in the next iteration.

Classes containing two neighbor nodes respectively are called adjacent classes. Noting that the only possible transformation of a class is refinement via splitting, Lemma 1 implies:
LEMMA 2. After the first iteration, a class splits if and only if one or more adjacent classes split in the previous iteration.

Consequently, updating nodes A and J is redundant after the second iteration because the unique adjacent class {BI} has never split.

### Class Splitting

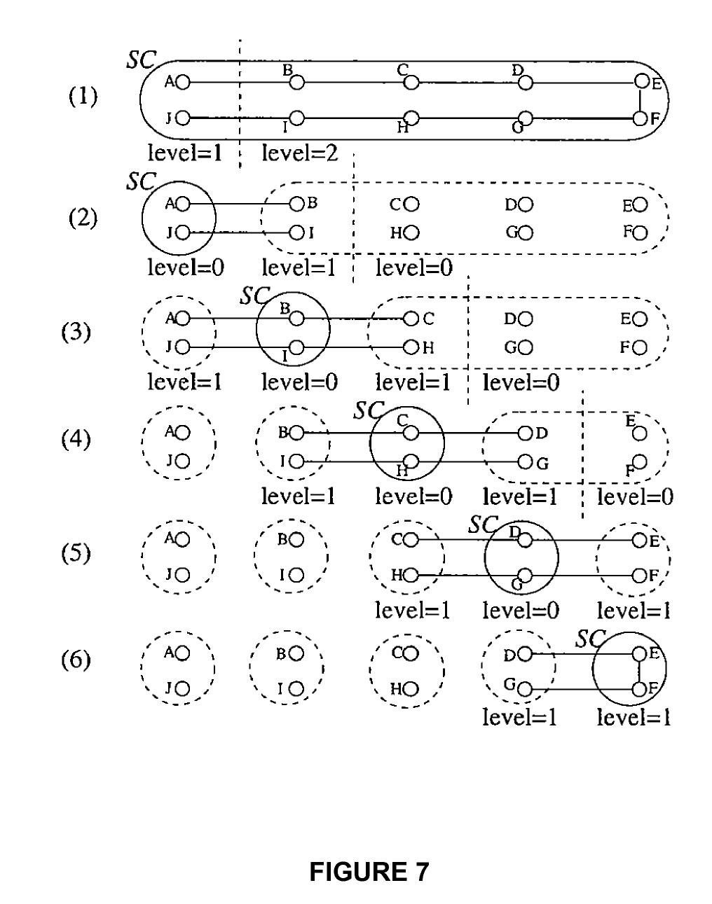

In each iteration; the proposed algorithm selects one class and updates only those nodes in its adjacent classes. The selected class is called a stimulant class (SC). A node is said to be on level n if it has exactly n neighbors in the SC (n could be zero). All adjacent classes of the SC split according to the levels of their nodes. For example, in third iteration of FIG. 7, let SC={BI} and it has two adjacent classes {CDEFGH} and {AJ}. In class {CDEFGH}, nodes C and H are on level 1 and nodes DEFG are on level 0. This results in nodes C and H being refined from DEFG. Meanwhile, all nodes in {AJ} are on level 1, thus are not split by {BI}. After a class has been used as SC, it is marked as “visited” and can no longer to be selected. Of course, class {CDEFGH} could also be the SC, but it cannot split {AJ} or {BI}. Usually large classes are more likely to be refined and they have more neighbors than small classes. Thus, various implementations of the invention may heuristically select the smallest unvisited class as the SC to improve performance. If all adjacent classes of some class are visited, the nodes in that class will not be updated.

After a class has been split, all but one of the derived classes are marked as “unvisited” and become new candidates to be the next SC. The special derived class is called the inheritor class (IC). It inherits the “visited” attribute from its parent class (PC). Explicitly, if the PC is unvisited, then all children are unvisited; if the PC is visited, then it can be shown that the IC need not be visited. Again, as a performance heuristic, the largest derived class may always be selected as the IC. If a class is unchanged in an iteration, it is the trivial IC of itself.

In FIG. 7, class {CDEFGH} in iteration (3) is the largest child of a visited class {BCDEFGHI} in iteration (2), thus the class {CDEFGH} does not need to be visited again.

### Initial and Terminal Conditions

An initial division of the nodes into classes is accomplished by computing a function of the local invariants (attributes) of the nodes (such as types, names if available, number of neighbors, etc.).

The algorithm stops when all classes have been visited and no singleton classes remain i.e., when all type-1 symmetries have been resolved. Type-2 symmetries may remain because they do not affect the equivalence of the graphs, and may be resolved arbitrarily if a complete list of matching nodes is desired, rather than a simple equivalent/not-equivalent decision.

### Complexity

The complete new algorithm is shown as Listing 2 below. The total run-time of the proposed algorithm is decided by (C·N·D·T), in which C is the number of stimulant classes over the algorithm execution, N is the average number of nodes in each stimulant class, D is the average number of neighbors of each node and T is the average time spent on stimulating each node. It can be shown that C is equal to the number of nodes in the graph.

Algorithm 2 New LVS Algorithm

| | |
|---|---|
| 1: | put all nodes in initial classes according to their invariants |
| 2: | mark all nodes as “unvisited”. |
| 3: | do |
| 4: | do |
| 5: | select the smallest unvisited class as SC |
| 6: | mark SC as “visited” |
| 7: | for each node k in the neighbor classes of SC |
| 8: | stimulate k to the upper level |
| 9: | splits all classes according to the levels of nodes |
| 10: | mark all derived classes but IC as “unvisited” |
| 11: | until all classes are visited. |
| 12: | if there is any ambiguity class |
| 13: | arbitrarily make a guess |
| 14: | until all classes are singleton. |
| 15: | if there is any unbalanced class |
| 16: | report that two graphs are different |
| 17: | else |
| 18: | report that two graphs are equivalent. |

### Listing 2

Since the smallest unvisited class is always selected as the SC and the largest child of a visited class is not visited, the size of the SC is typically very small except in the first few iterations. In practice, N can be approximated by a small constant. It can be shown that C·N in the worst case cannot be larger than

$$n + \frac{n}{2} {log}_{2} n .$$

The worst case shown in FIG. 7 hardly ever happens in practice for n>16 because usually many SC candidates have been refined before they are chosen as the SC.

With the exception of power supplies or clock nets, the number of neighbors of a node is rather limited in practice, thus D varies in a small range and can be treated as a constant for similar types of circuits.

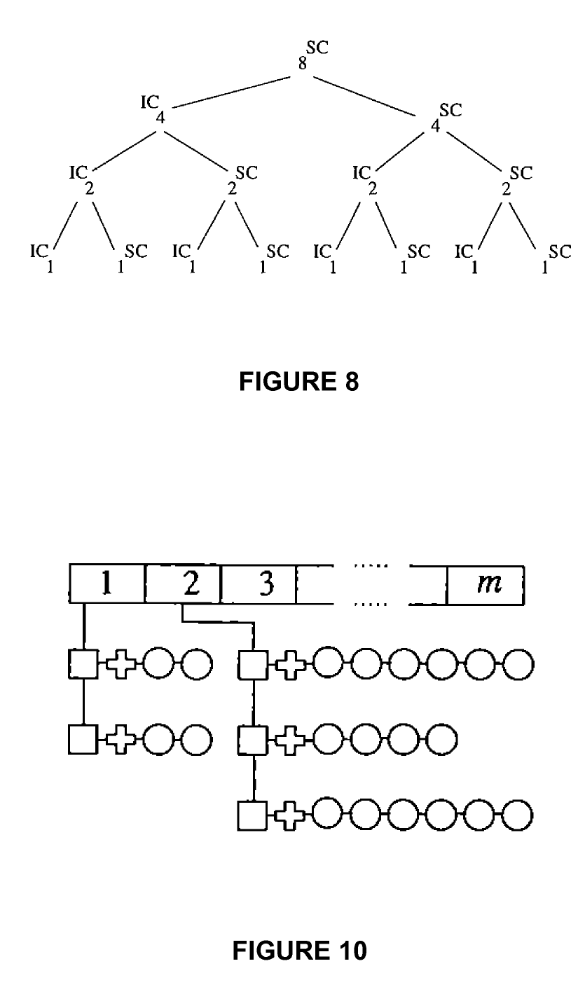

Using the data structure explained in the next section, T can also be realized in constant time. Based on the above analysis, the complexity of the new algorithm is close to O(n) in practice and not larger than O(n log n) in the worst case, as shown in FIG. 8.

### Data Structures

Five fundamental operations are employed according to the techniques provided by various implementations of the invention:
(1) stimulate a node to a higher level;
(2) refine (split) a class;
(3) select the largest child class;
(4) select the smallest unvisited class; and
(5) select a pair of nodes to be matched in a non-singleton class.

In order to ensure that the overall algorithm complexity is not degraded below O(n log n), all of these operations should be completed in constant time. This can be achieved by use of a doubly linked list data structure.

### Transition

All nodes on the same level in a class are organized with a doubly-linked list. Two head-nodes are inserted in front of this list. The first one is called class-head which is used to access all nodes in a class. The second one is called level-head which is used to access all nodes on same level in a class. The level-head has a field pointing to the next level-head in same class, thus the level-heads themselves forms a linked list. These lists correspond to the levels of nodes. The nodes in the first list are on level•0, the nodes in the second list are on level 1, the next one is level 2, and so on.

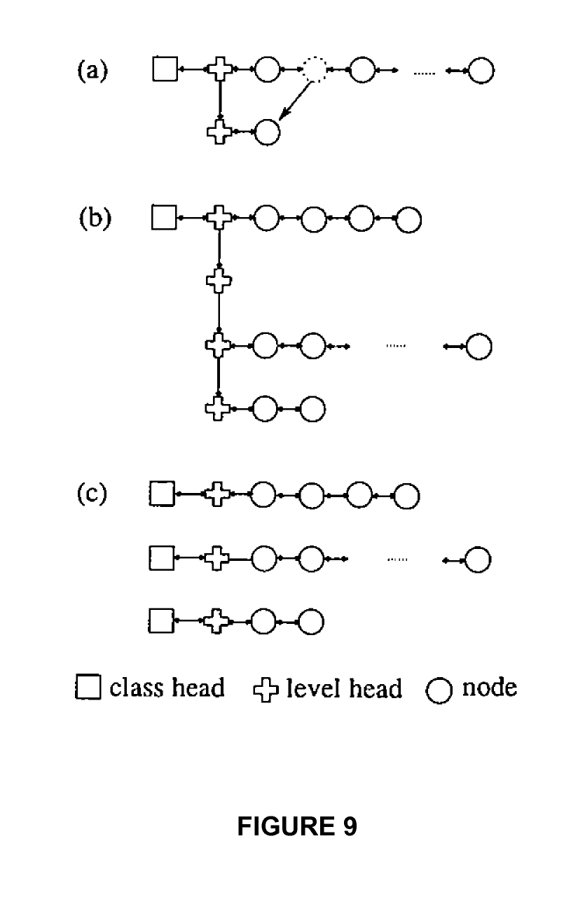

When a node is visited in the new algorithm, all its neighbors are stimulated to a higher level. This operation is called a transition. In a doubly-linked list structure, given a pointer to the level-head, the transition operation can be done in three steps (see FIG. 9(a)):
(1) if the current level-head is the last one in the class, create a new empty level-head after it;
(2) remove the node from the current level; and
(3) insert the node into the next level.

After visiting all nodes in the SC, each adjacent class may have several levels and some of them might be empty (see FIG. 7(b)). All non-empty levels are popped out of the class and promoted to new classes by adding a corresponding class-head (see FIG. 7(c)). The largest derived class is set to be the IC and have the same “visited” attribute as the parent class. Others are set to be “unvisited”. At this time, all classes have only one level. The average number of levels in a class is close to a constant D as explained above.

### Groups

A set of classes is called a group and can also be represented by a doubly linked list. Thus a class can be inserted into or removed from a group in constant time. The visited classes are always inserted into the end of a group and the unvisited classes are always inserted at the front of a group. Checking whether all classes in a group are visited can be done in constant time by looking up the status of the first class in the list.

In order to find the smallest unvisited class, all classes are sorted by size and stored in an array of groups (see FIG. 10). If the sizes of classes are used as the index of groups, this array could have O(n) entries in the worst case which is relatively large. Instead, logarithmic indexes may be used and the number of entries bounded by log₂ n. The array is scanned from the first entry to the last entry and the first unvisited classes is returned. Usually the unvisited classes can be found in the first several entries, thus the time complexity is close to O(n).

When a node is stimulated to a new level, its class becomes dirty. Except for singleton classes, all dirty classes are removed from the group array and inserted into a temporary group called the dirty-group. At the end of each iteration, all classes in the dirty group are split and put back into the group array by their new sizes.

### Experiments

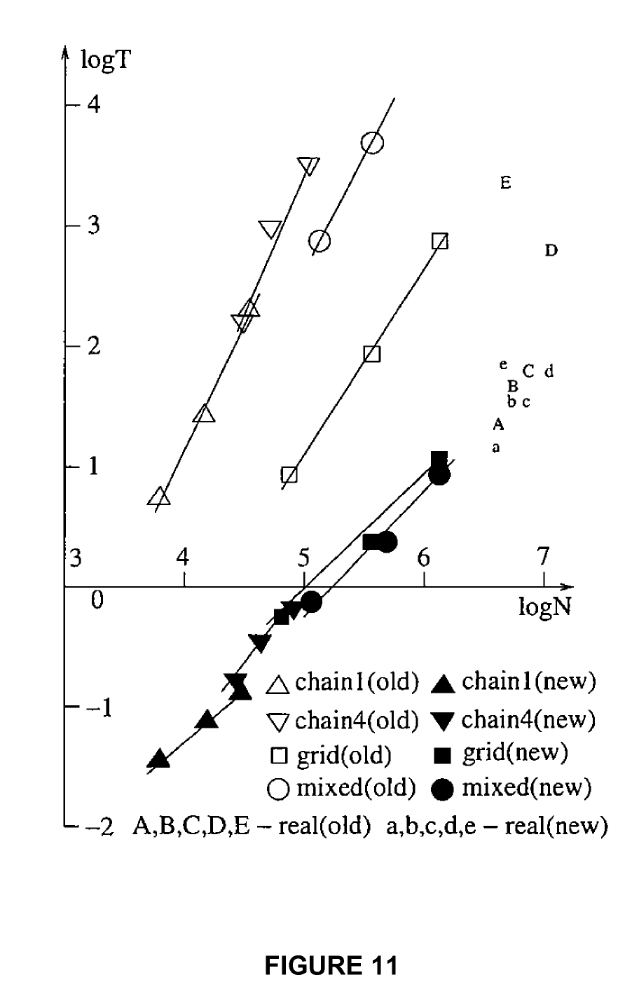

A program was written to validate an implementation of the invention described in detail above. Table 2 below and FIG. 11 show the results of the chain1, chain4 and grid examples (illustrated in FIG. 5) of different sizes.

TABLE 2
Experiments

| | # of nodes | runtime (old) | runtime (new) |
|---|---|---|---|
| chain1a | 8,001 | 6 sec | 0.029 sec |
| chain1b | 16,001 | 36 sec | 0.057 sec |
| chain1c | 32,001 | 184 sec | 0.132 sec |
| chain4a | 28,001 | 177 sec | 0.15 sec |
| chain4b | 56,001 | 1103 sec | 0.30 sec |
| chain4c | 112,001 | 3910 sec | 0.59 sec |
| grida | 76,480 | 8 sec | 0.48 sec |
| gridb | 306,560 | 71 sec | 2.1 sec |
| gridc | 1,227,520 | 645 sec | 10 sec |
| mixeda | 112,482 | 718 sec | 0.68 sec |
| mixedb | 378,562 | 5614 sec | 2.6 sec |
| mixedc | 1,371,522 | * | 11 sec |
| reala | 3,775,912 | 24 sec | 17 sec |
| realb | 5,150,276 | 40 sec | 30 sec |
| realc | 8,224,643 | 68 sec | 39 sec |
| reald | 10,550,372 | 620 sec | 53 sec |
| reale | 5,045,137 | 2491 sec | 80 sec |

*run out of memory

The “old” runtimes were obtained using a current popular commercial LVS tool, while the “new” runtimes were obtained by employing an implementation of the invention. The “mixedx” examples are graphs including 3 independent subgraphs corresponding to a chain 1, chain4 and grid respectively. For example, mixeda has a copy of chain 1a, a copy of chain4a and a copy of grida. The layout and schematic graphs are identical but their net-list files have the order of instances arranged randomly. The “realx” test cases are derived from industrial circuits. In all cases, device reduction is not applied and only the type of instances and degrees of nets are used as initial invariants.

The results show that the runtime of the new algorithm is indeed close to O(n). Note that in the traditional algorithm, the runtime of mixed examples is much larger than the sum of the runtimes of the corresponding individual examples. In the new algorithm, the runtime of the overall graph is almost equal to the sum of the run-times of its sub-graphs.

What is claimed is:

1. A method of comparing a first design of an integrated circuit with a second design of the integrated circuit, comprising:
comparing a first graph representing the first design with a second graph representing the second design using the comparison algorithm substantially as listed in List 2; and
if the first graph and the second graph are determined to be equal, determining that the first design is equal to the second design, and
if the first graph and the second graph are determined to be unequal, determining that the first design is not equal to the second design.

2. The method recited in claim 1, wherein
the first design is a layout design of the integrated circuit, and
the second design is a schematic design of the integrated circuit.
